(19) United States
(12) Patent Application Publication
(10) Pub. No.: US 2006/0153133 A1
(43) Pub. Date: Jul. 13, 2006

(54) System and method for performing a fast handoff in a wireless local area network

(75) Inventor: Zhun Zhong, Croton-on-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,113

(22) PCT Filed: Nov. 27, 2003
(86) PCT No.: PCT/IB03/05517

§ 371 Date: Jun. 8, 2005

Related U.S. Application Data
(60) Provisional application No. 60/432,534, filed on Dec. 11, 2002.

(51) Int. Cl. H04Q 7/00

(52) U.S. Cl. 370/331

(57) ABSTRACT

Disclosed is a system and method for performing a fast channel scan so as to minimize the communication disruption period (10) which occurs during a handoff of a mobile station (STA) (20-23) in a wireless local area network (WLAN) (100). Each mobile station (STA) includes an associated nearest-neighbor table identifying nearest-neighbor APs (14-16) in the network to the AP with which the STA is currently associated. When a STA (20-23) performs a handoff, its nearest-neighbor table is used to perform a prioritized search of those channels of operation included in the table belonging to nearest-neighbor APs (14-16). In this manner, by prioritizing the search to first search the channels of operation belonging to nearest-neighbor APs (14-16), there is a greater likelihood of locating a candidate ap (14-16) to form an association with in less time as compared with the prior art search method of blindly searching each and every operating channel in the network.

This invention generally relates to local area networks and more particularly to a system and method for performing fast handoffs in a wireless local area network.

The IEEE 802.11 standard defines two operating modes, an Ad hoc mode and an Infrastructure mode. In the ad hoc mode, also known as peer-to-peer mode, wireless stations (STA) communicate directly with each other without the use of an access point (AP). Two or more wireless STAs who communicate using ad hoc mode form an Independent Basic Service Set (IBSS). Ad hoc mode is used to connect STAs within radio range when an AP is not present. In infrastructure mode, there is at least one AP and one STA. An AP and the one or multiple STAs it supports is known as a Basic Service Set (BSS). The STA uses the AP to access the resources of a wired network, as well as to communicate with the other STAs within the same BSS. The wired network can be an organization intranet or the Internet, depending on the placement of the AP. A set of two or more BSSs connected by the distributed system (DS) is known as an Extended Service Set (ESS), identified by its Service Set Identifier (SSID). If the radio coverage areas of the APs overlap, then a STA can roam, or move from one location (within the BSS of one AP) to another (within the BSS of a different AP) while maintaining network layer connectivity. This process is referred to as a “handoff”.

When a handoff occurs in the IEEE 802.11 WLAN, the communication link between the STA and the current AP is broken down and a new communication link must be established between the STA and a new AP. The STA initiates this process when it detects that the link quality with the current AP has degraded below a specific threshold. The STA then begins looking for another AP, most likely in a different radio frequency.

During the handoff procedure, a communication disruption period occurs starting from the time the existing communication link is broken down until the time when the new link is established.

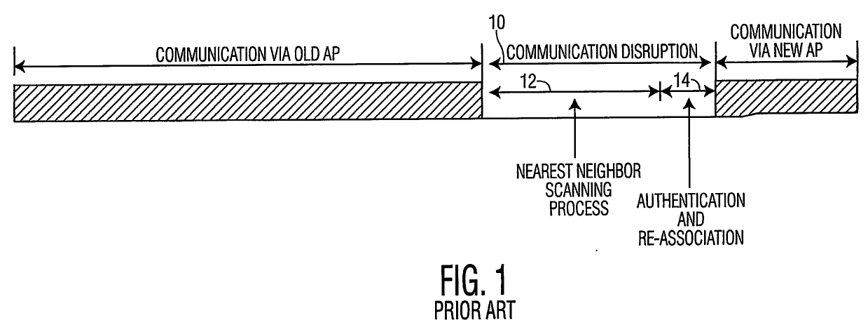

FIG. 1 illustrates this communication disruption period 10. As shown, the communication disruption period 10 is comprised of a nearest-neighbor scanning process 12 and an “authentication and re-association” process 14. During the nearest-neighbor scanning process 12, an STA will send probe requests in every radio frequency channel and wait for APs, if any, to reply with probe responses. This channel scanning process can take up to several hundred milliseconds as a consequence of, in the worst cases, having to scan up to 11 overlapping channels as defined in the 802.11b standard and up to 12 non-overlapping channels as defined in the 802.11a standard. The second process, “authentication and re-association” 14, as defined in the current standard, by comparison takes only tens of milliseconds to complete. It should be noted that the channel scanning process 12 dominates the communication disruption period 10.

Accordingly, the present invention proposes a new mechanism for performing the channel scanning process that can be implemented in the IEEE 802.11 environment.

The present invention is directed to a system and method for performing a fast channel scan so as to minimize the communication disruption period which occurs during a handoff of a mobile station (STA) in a wireless local area network (WLAN).

According to one aspect of the invention, a method for performing a fast handoff includes the acts of: (a) providing a plurality of APs in the network with an assigned channel of operation and a pre-configured nearest-neighbor table comprised of records, where each record includes at least a first field identifying a nearest neighbor AP and a second field identifying said nearest neighbor AP's channel of operation; (b) transmitting said pre-configured nearest-neighbor table from said plurality of APs to associated STAs; and (c) using said nearest-neighbor table, said STA performing a prioritized search by first searching in each of said nearest neighbor AP's channel of operation from said table to locate at least one candidate AP to form a new association with in said handoff.

According to yet another aspect of the invention, a system for performing a fast handoff includes: means for providing a plurality of APs in the network with an assigned channel of operation and a pre-configured nearest-neighbor table comprised of records, where each record includes at least a first field identifying a nearest neighbor AP and a second field identifying said nearest neighbor AP's channel of operation; means for transmitting said pre-configured nearest-neighbor table from said plurality of APs to associated STAs; and means for using said nearest-neighbor table, said STA performing a prioritized search by first searching in each of said nearest neighbor AP's channel of operation from said table to locate at least one candidate AP to form a new association with in said handoff.

According to one embodiment of the invention, each AP in the network is initially configured with an unpopulated (empty) nearest-neighbor table and as handoffs are performed in the network the APs learn who its nearest neighbors are and update their tables accordingly. Over some period of time, as learning proceeds, the AP's nearest-neighbor tables gradually transition from their initially unpopulated state to a fully populated or in some cases a substantially populated state.

The foregoing features of the present invention will become more readily apparent and may be understood by referring to the following detailed description of an illustrative embodiment of the present invention, taken in conjunction with the accompanying drawings, where:

FIG. 1 illustrates the process by which an STA is handed off from an old AP in the network to a new AP in the network;

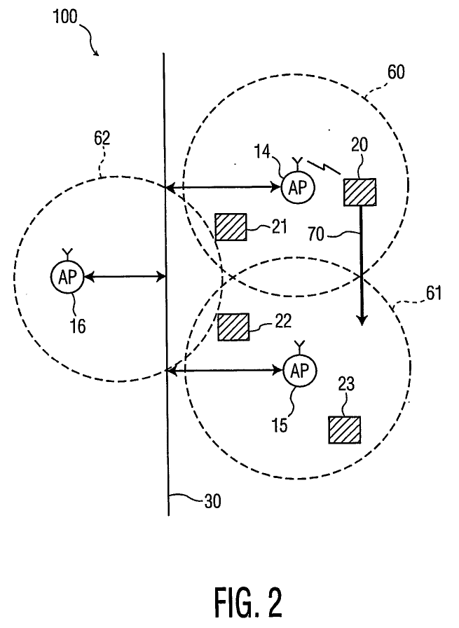

FIG. 2 illustrates a wireless network embodying the present invention;

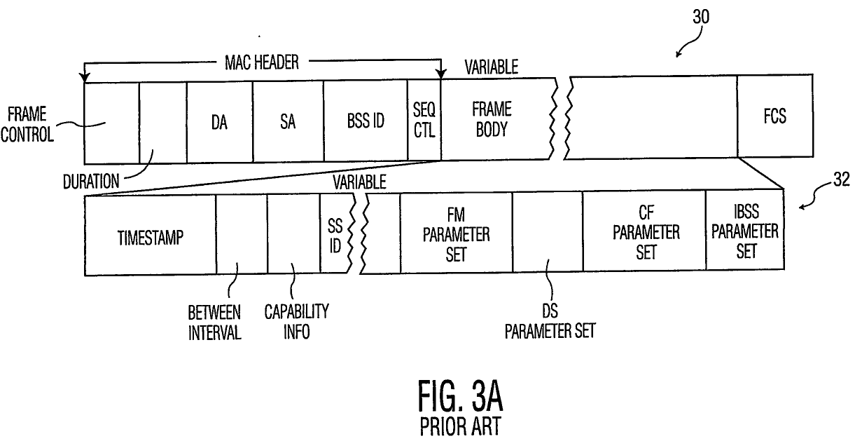

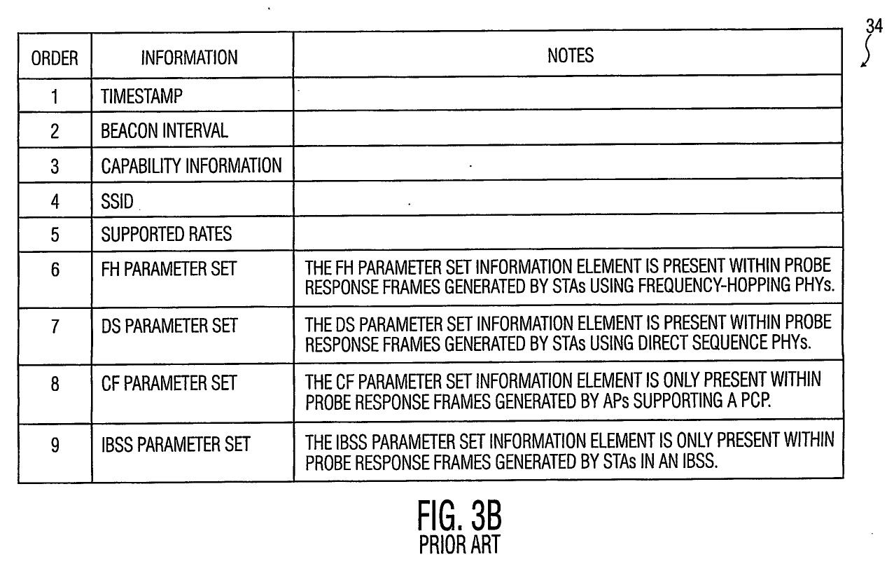

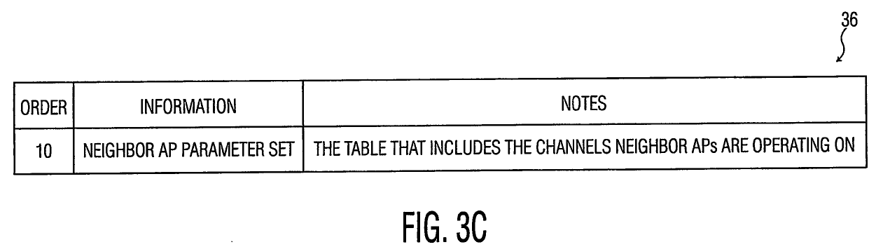

FIG. 3a illustrates the format of a conventional probe response frame as defined by the IEEE 802.11 standard;

FIG. 3b illustrates the fields which make up the conventional probe response frame of FIG. 3a;

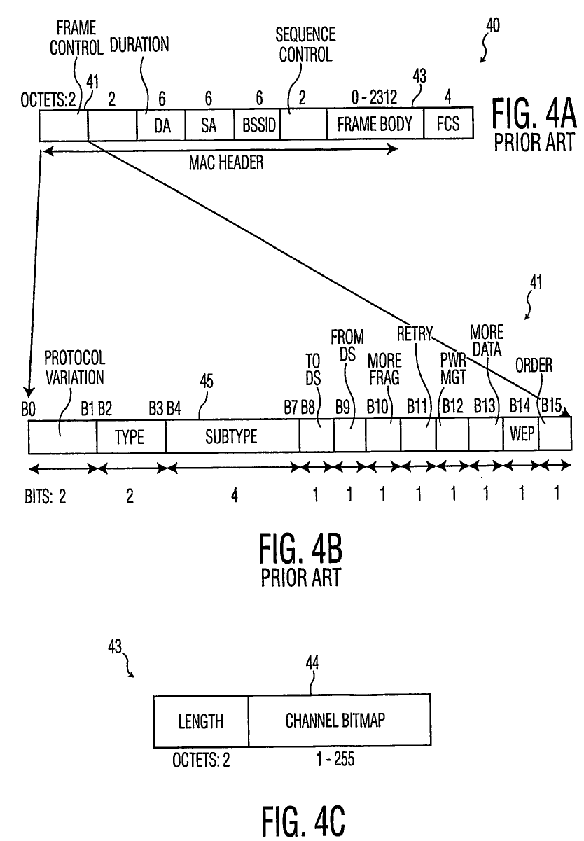

FIG. 4a illustrates a conventional management frame format 40 as defined by the 802.11 standard;

FIG. 4b illustrates the fields which make up the Frame Control field of the management frame of FIG. 4a;

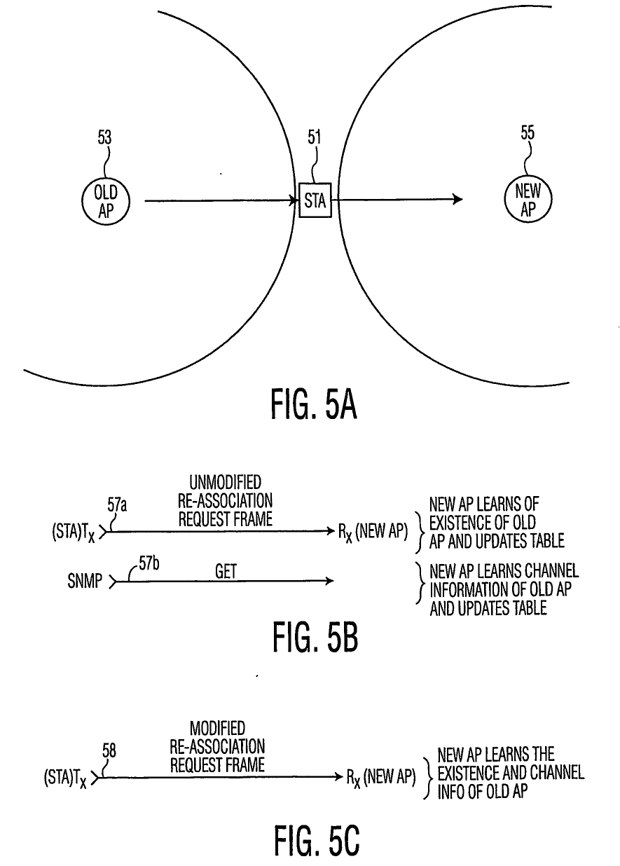

FIGS. 5(a)-(c) illustrate methods by which an AP learns of the identity and channel of operation of a neighbor AP in accordance with one embodiment of the invention;

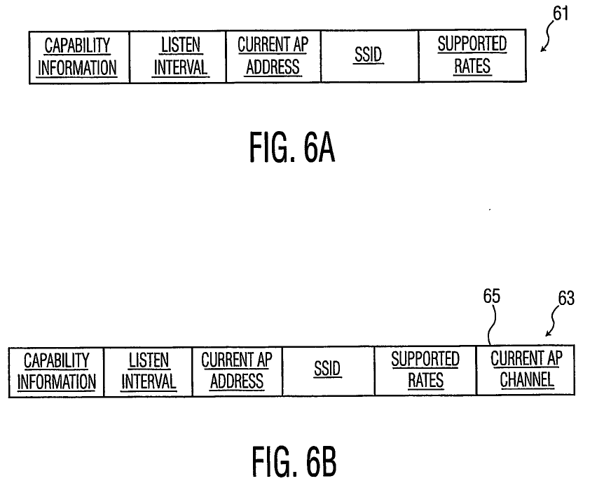

FIG. 6a illustrates a conventional re-association frame as currently defined in the 802.11 standard;

FIG. 6b illustrates a modified re-association frame in accordance with a method of the invention;

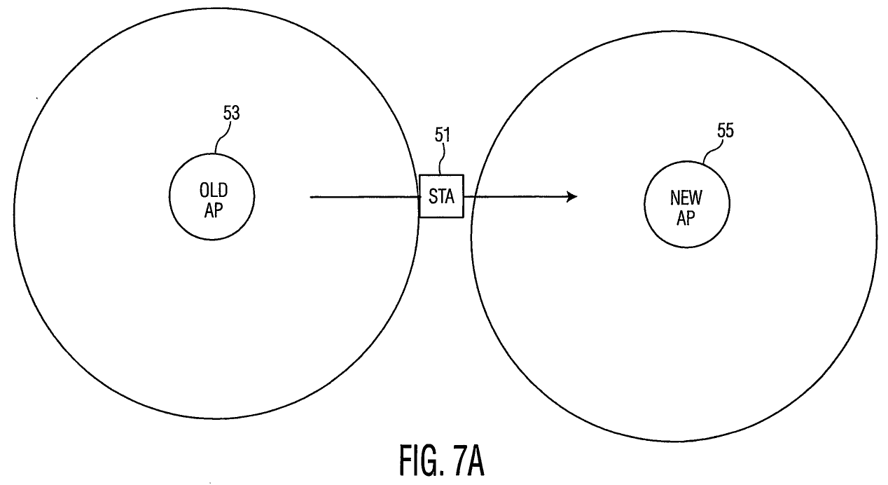

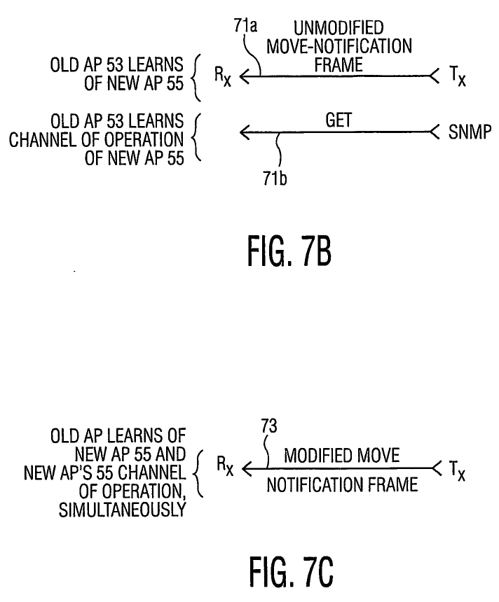

FIGS. 7(a)-(c) illustrate methods by which an AP learns of the identity and channel of operation of a neighbor AP in accordance with one embodiment of the invention;

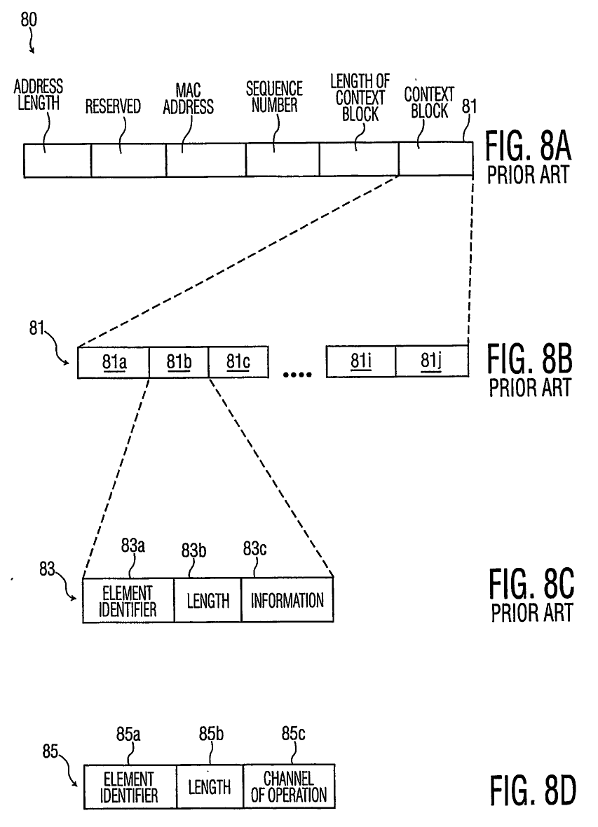

FIG. 8a illustrates a conventional move-notification frame body as currently defined in the IAPP;

FIG. 8b shows a more detailed illustration of the context block field of the move-notification frame body of FIG. 8a;

FIG. 8c illustrates a generic context block element, and

FIG. 8d shows a new element which may be added to the existing context block of the move-notification frame body of FIG. 8a to transmit the channel of operation of the new AP.

In the following detailed description of the present invention, numerous specific details are set forth in order to provide a thorough invention may be practiced without these specific details. In some instances, well-known structures and devices are shown in block diagram form, rather than in detail, in order to avoid obscuring the present invention.

Overview

Each of the embodiments described herein are directed to minimizing the nearest neighbor scanning time during a handoff of an STA in a WLAN. This is generally achieved, in accordance with the principles of of the invention, whereby the STAs perform a prioritized search by first searching those channels of operation corresponding to APs who are the nearest neighbors of the AP to which the STA is currently associated with. The method affords advantages over prior art channel scan methods which operate by blindly searching all of the operating channels in the network to locate an AP handoff candidate.

Operating Environment

FIG. 2 illustrates a wireless network 100 embodying the present invention. The wireless network 100 generally comprises one or more access points (APs) 14-16. The APs 14-16 communicate bi-directionally via bus 30, which is typically a hard-wired connection (e.g, Ethernet). APs 14-16 also communicate with one or more mobile stations (STAs) 20-23 by wireless link. Each AP 14-16 can transmit data to and receive data from STAs 20-23 that are within the specified broadcast range of the AP. For example, APs 14-16 have respective broadcast ranges 60-62. AP 14 can communicate with STA 20 and STA 21 and AP 16 can communicate with STA 22 and STA 23. The transmission and reception of data is preferably in accordance with the IEEE 802.11 standard.

Although the exemplary broadcast coverage areas 60-62 are circular in shape, it is possible for the broadcast area of an AP to assume other irregular shapes. The shape and size of the coverage area of an AP is frequently determined by obstructions that prevent the transmission of signals between the AP and an STA.

As the STAs 20-23 move about in the wireless LAN environment, the STAs 20-23 enter and leave the respective coverage areas 60-62 of different APs 14-16. For example, as STA 20 moves in the direction of path 70, STA 20 moves away from its currently associated access point, AP 14, to a new access point, AP 15. At some point in its movement along path 70, STA 20 determines that the signal quality of the link with the currently associated AP 14 has degraded below (or at least close to) an acceptable threshold level. When this occurs, STA 20 begins scanning nearest-neighbors for another AP in order to set up a “handoff”.

At the point in time at which STA 20 decides to perform a conventional handoff, the STA 20 blindly scans each and every possible operating channel in the network to find candidate APs 15-16. As stated above, and illustrated in FIG. 1, this conventional channel scanning approach is time consuming. In some instances, several hundred milliseconds may be required to complete the search. This lengthy communication disruption time may be minimized in accordance with the embodiments described below.

### First Embodiment

With continued reference to the illustrative network of FIG. 2, according to a first embodiment, each AP 14-16 in the network 100 is provided with a nearest-neighbor table, during a configuration stage (i.e., prior to the operational stage of the network). The nearest-neighbor table for each AP 14-16 includes one or more records identifying the AP's immediate neighbor APs in the network and their corresponding channel of operation. For example, with reference to the exemplary network of FIG. 2, a nearest-neighbor table for AP 15 is shown in Table I as:

TABLE I
Nearest-Neighbor Table for AP 15

| | Nearest-neighbor channel of |
|---|---|
| Nearest Neighbor | Operation |
| 14 | 1 |
| 16 | 6 |

As shown in table I, AP 15 has two nearest neighbors, AP 14 and 16 operating on channels 1 and 6, respectively. The table may be stored in a memory associated with the AP at the configuration stage.

In accordance with the present embodiment, the table values may not be changed after they are assigned at the configuration stage. The table values are considered static as a result of the AP's being stationary (non-mobile) and the channel allocations being fixed by the system administrator. The ability to modify or change an initial channel allocation is allowed in the second and third embodiments to be described below.

Subsequent to the tables being assigned to the APs during configuration, thereafter, during an operational stage, it is necessary to communicate the table information from the APs to STAs associated with the APs to enable the STAs to perform handoffs in accordance with the method of the invention.

Described now are three alternative methods for communicating the nearest neighbor table information from the APs to the STAs. It is noted that the three methods to be described are applicable to all embodiments disclosed herein.

In accordance with a first method of communicating the table information from an AP to an STA, a modified probe response frame is used to convey the table information. Specifically, a conventional probe response frame is modified to include an additional field for transmitting the table information, as described with reference to FIGS. 3a and 3b.

FIG. 3a illustrates the format of a conventional probe response frame 30 including the details of the probe response frame body 32 as defined by the IEEE 802.11 standard. As is well known to those in the art, a probe response frame is a type of management frame that is used together with probe request frames. Probe request frames are used by the STAs to scan a channel for an AP to associate with. If a probe request issued by an STA encounters an AP with compatible parameters, the AP sends a probe response frame, such as the one shown in FIG. 3a. The probe response frame carries all of the parameters necessary for the STA to join the network.

FIG. 3b describes the fields which make up the conventional probe response frame body 32. Nine fields are shown.

FIG. 3c illustrates an additional field (tenth field) which may be included in the conventional probe response frame body of FIG. 3a as a means of communicating the table information from an AP to an STA.

In accordance with a second method for communicating the table information to the STAs, a conventional beacon frame is modified in a manner similar to that described above for the probe frame. As is well known to those in the art, beacon frames are issued by APs in a BSS network to announce the existence of the network and are transmitted at regular intervals to allow STAs to find and identify a network, as well as match parameters for joining the network. The modification made to the beacon frame for transmitting table information is similar to that described above with reference to FIG. 3 for the probe frame. That is, an additional field may be added to a conventional beacon frame for transmitting the table information.

In accordance with a third method for communicating the table information from an AP to its associated STAs, a new dedicated management frame may be used.

FIG. 4a illustrates a conventional management frame format 40 as defined by and used in accordance with the 802.11 standard.

FIG. 4b illustrates the fields which make up the Frame Control field 41 of management frame 40. As shown, the Frame Control field 41 includes, inter alia, a “Subtype” field 45. In the current IEEE 802.11 standard, subtype values 0110-0111 are currently reserved values. It is proposed to use one of the reserved subtype values for the dedicated management frame, which may be referred to as a “neighbor AP channel announcement” frame. The dedicated management frame 40 can be broadcast to the BSS, or unicast to any particular STA in the BSS, whenever necessary (e.g, whenever the nearest neighbor table at the AP is updated).

FIG. 4c illustrates the frame body 43 of the dedicated management frame 40 as a bitmap of channels. An example of how the bitmap could be utilized in the dedicated management frame 40 to transmit table information is for each position of the channel bitmap to represent a channel of operation in the network A zero value could indicate no APs operating on that channel and a one value could indicate the presence of an AP. As a specific example, consider the simplified bitmap value, “01011”. In this bitmap only five channels are represented for ease of explanation, with APs operating on channels 2, 4 and 5 and no APs operating on channels 1 and 3.

Once an STA has acquired the nearest neighbor table information from an AP in accordance with one of the above described methods (i.e., modified probe frame, modified beacon frame, new management frame), when the STA decides thereafter to perform a handoff, the STA uses the nearest neighbor table provided by the AP to perform a handoff in accordance with the method of the invention as will be described.

Referring again to FIG. 2, an example is now provided of how the nearest neighbor information table information may be used by an STA to perform a handoff in accordance with the method of the invention.

Assume in the example that STA 20 has acquired the nearest-neighbor table from AP 14 in accordance with one the three methods described above. When STA 20 thereafter decides to perform a handoff, STA 20 utilizes the provided nearest-neighbor table information by accessing the nearest-neighbor table records to determine the channel of operation for each nearest-neighbor AP record. In the instant example, the STA 20 would access its nearest-neighbor table (Table I) and determine from the two records that APs 14 and 16, are operating on channels 1 and 6, respectively. Thereafter, the STA 20 performs a prioritized search starting with the scan of channels 1 and 6 to locate a candidate AP to form a new association. A key feature of the invention is that by first scanning those channels associated with nearest neighbor APs, there is a greater likelihood of locating a candidate AP more quickly as compared with blindly searching each and every operating channel in the network. It should be noted, however, that the prioritized search makes no guarantees for finding a candidate AP, however, in most instances, the method will produce a successful result in less time as compared with the prior art approach. However, in the event the prioritized search does not identify a candidate AP for a handoff, the method then proceeds to search those remaining channels of operation defined in the network which were not included in the nearest-neighbor table.

### Second Embodiment

The second embodiment incorporates the features of the first embodiment with one important exception. That is, the APs in the network are allowed to dynamically change their channel allocations from what was initially assigned during configuration. It is important to note, however, when an AP decides to change its channel allocation, the change must somehow be communicated to the neighboring APs to allow the neighboring APs to update their nearest-neighbor tables.

One way of an AP informing its neighboring APs of a channel change is through the Simple Network Management Protocol (SNMP) which is designed for exchanging network management information. The nearest-neighbor table can be stored as a tabular Management Information Base (MIB) object which can be read and set via the SNMP.

Once the APs decides to change its channel allocation, it should inform its neighbor APs via the SNMP protocol. After each neighbor AP updates its respective table to reflect the change, the neighbor APs should then forward the updated table to the associated STAs in their service sets using one of the two methods described above, namely, either the modified beacon frame or the dedicated management frame.

### Third Embodiment

In contrast to the previous two embodiments, in the present embodiment, the APs are not pre-configured with fully populated nearest-neighbor tables. Instead, each of the APs start their operation with an empty (unpopulated) nearest-neighbor table and in accordance with a method to be described, learn who their nearest-neighbors are as handoffs occur in the network. As the APs learn who their nearest neighbors are over some period of time in the network, their nearest-neighbor tables transition from the initially empty state to a fully populated or substantially populated state.

The present invention recognizes that it may not always practical to pre-populate the nearest-neighbor tables during configuration. This impracticality may come about for a number of reasons including, the APs being mobile APs in which case the APs are nearest neighbors for only transitory periods; or where the APs are associated with different administrative domains and therefore not amenable to being configured by a single administrative entity; or where the network is extremely large (i.e., hundreds to possibly thousands of APs), in which case manually pre-populating each APs nearest-neighbor table may be prohibitively time-consuming.

In accordance with the present embodiment, each AP and STA in the network start out by operating with empty (unpopulated) nearest-neighbor tables. During the normal course of network operation, it is assumed that the STAs will perform some number of handoffs, as is conventional. It is during these handoffs that the APs have an opportunity to “learn” about the existence and channel of operation of their nearest-neighbor APs in the network and populate their nearest-neighbor tables as they learn.

FIG. 5a illustrates a typical handoff where STA 51 initiates a handoff from its formerly associated AP 53, referred to as the ‘old’ AP, to form a new association with AP 55, referred to as the ‘new’ AP.

FIG. 5b illustrates one way in which an AP learns about a neighbor AP in accordance with the present embodiment. Specifically, FIG. 5b illustrates one method by which the new AP 55 learns about the old AP 51 and also about the old AP's corresponding channel of operation. As a requirement of the IEEE 802.11 standard, when handoffs are performed, the STA 51 initiating the handoff sends a re-association frame 57a to the new AP 55 to form a new association. As defined by the standard, the re-association flame includes the identity of the old AP 53. Upon receiving the re-association frame at the new AP 55, which includes the identity information of the old AP 51, the new AP 55 effectively ‘learns’ that the old AP 51 is a nearest neighbor and updates its nearest-neighbor table accordingly. Thereafter, an SNMP 57b is sent from the new AP 53 to learn the corresponding channel of operation of the old AP 51.

As an alternative to the approach described above, in FIG. 5c another method for learning the identity and corresponding channel of operation of the old AP 51 is shown. In accordance with this method, the re-association frame is modified 58 to incorporate the channel of operation of the old AP 51. In this way, there is no need for the SNMP 57b. Thus, a modified re-association request frame 58 provides all of the necessary information to completely update the nearest-neighbor table of the new AP 55 in a single operation. The manner in which a conventional re-association frame may be modified is described below with reference to FIGS. 6a and 6b.

FIG. 6a illustrates a conventional re-association frame body 61 as currently defined in the 802.11 standard. The frame body 61 is used in accordance with the first method (see 57a).

FIG. 6b illustrates a modified re-association frame body 63 of FIG. 6a modified to include a “Current AP channel” field 65 for transmitting the channel of operation of the old AP 53.

In addition to providing a mechanism by which the new AP 55 can learn about the identity and channel of operation of the old AP 53, as described above. The present embodiment provides a mechanism by which the old AP 53 may learn about the existence and channel of operation of the new AP 55.

Referring first to FIG. 7a, there is shown, for ease of explanation, the handoff first illustrated in FIG. 5a. When the new AP 55 accepts the STA 51 in the handoff, according to the Inter-Access Point Protocol (IAPP), the new AP 55 would then send a move-notification frame to the old AP 71a over the wired backbone 30, as illustrated in FIG. 7b. The move-notification frame includes information about the STA 51 as well as the new AP 55. Upon receiving the move-notification frame at the old AP 53, the old AP 53 effectively learns that the new AP 55 is a nearest neighbor.

It is noted that, unlike the process described above with respect to FIGS. 5(a)-(c), in which the IEEE standard mandates the use of re-association frames when performing handoffs, the move-notification frame is not a requirement of the IEEE standard but only a recommended practice in accordance with the IAPP. As such, there is no guarantee that every deployed system will incorporate this feature. However, by simply reversing the direction of the STA 51 in FIG. 5a, the identities of the two APs (i.e., old and new) are reversed and in this situation AP 55 learns of AP 53 in accordance with the standard without incurring the use of the move-notification frame.

Referring now to FIG. 7c, the move-notification frame may be modified 73 to incorporate the channel information of the new AP 55 act 73. In this manner, only a single communication of a modified move-notification frame is required to communicate the required table information from the new to the old AP (act 73).

FIGS. 8a-8d illustrate how a conventional move-notification frame may be modified to include the channel of operation information as described at act 73 of FIG. 7.

FIG. 8a illustrates a conventional move-notification frame body 80 as currently defined in the IAPP including a context block.

FIG. 8b illustrates a more detailed illustration of the context block 81 as being comprised of a plurality of information elements 81a-j.

FIG. 8c illustrates a generic information element 83 of the context block 81 made up of an element identifier 83a, a length field 83b and an information field 83c.

FIG. 8d illustrates a new information element 81k which may be added to the context block 81 so as to modify the conventional move-notification frame body 80 to facilitate the transmission of the channel of operation information of the new AP 55 to the old AP 51.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. A method for minimizing a communication service disruption period during a handoff of a mobile station (STA) in a wireless local area network (WLAN), the method comprising the acts of:
(a) providing a plurality of APs in the network with an assigned channel of operation and a pre-configured nearest-neighbor table comprised of records, where each record includes at least a first field identifying a nearest neighbor AP and a second field identifying said nearest neighbor AP's channel of operation;
(b) transmitting said pre-configured nearest-neighbor table from said plurality of APs to associated STAs; and
(c) performing a prioritized search by said STA by first searching in each of said nearest neighbor AP's channel of operation as identified in said transmitted nearest-neighbor table to locate at least one candidate AP to form a new association with in said handoff.

2. The method of claim 1, further comprising the act of sequentially searching those remaining channels of operation in said network not included in said table in the case where said at least one candidate AP was not located at said act (c).

3. The method of claim 1, wherein transmitted pre-configured nearest-neighbor table is transmitted at said act (b) via a modified probe response frame including said pre-configured nearest-neighbor table.

4. The method of claim 3, wherein said modified probe response frame is transmitted in response to a probe request by said STA.

5. The method of claim 1, wherein said transmitted pre-configured nearest-neighbor table is transmitted at said act (b) via a modified beacon frame including said pre-configured nearest-neighbor table.

6. The method of claim 1, wherein said transmitted pre-configured nearest-neighbor table is transmitted at said act (b) via a dedicated AP channel announcement management frame including said pre-configured nearest-neighbor table.

7. The method of claim 6, wherein said dedicated AP channel announcement management frame is broadcast to a BSS or unicast to a particular STA in said BSS.

8. The method of claim 6, wherein said nearest-neighbor table information is represented as a bitmap in said dedicated AP channel announcement management frame.

9. The method of claim 1, further comprising the acts of:
changing said assigned channel of operation by one of said plurality of APs; and
performing a frame exchange in accordance with a simple network management protocol (SNMP) between said one of said plurality of APs and all other APs to inform said all other APs of said channel change.

10. A method for minimizing a communication service disruption period during a handoff of a mobile station (STA) in a wireless local area network (WLAN), the method comprising the acts of:
(1) transmitting a re-association frame from said STA to a first AP, said re-association frame including a second AP identifier;
(2) upon receiving the re-association frame at said first AP, storing said second AP identifier in a nearest neighbor table associated with said first AP;
(3) obtaining, by said first AP, a channel of operation corresponding to said second AP; and
(4) storing said channel of operation in said nearest-neighbor table.

11. The method of claim 10, wherein said first AP is an AP with which said STA is attempting to form an association with in said handoff and said second AP is an AP with which said STA is currently associated with.

12. The method of claim 10, wherein said act (3) of obtaining, by said first AP, a channel of operation corresponding to said second AP is achieved via a frame exchange between said first and second APs performed in accordance with a simple network management protocol (SNMP).

13. A method for minimizing a communication service disruption period during a handoff of an STA in a wireless local area network (WLAN), the method comprising the acts of:
(1) transmitting a re-association frame from said STA to a first AP, said re-association frame including at least a second AP identifier and said second AP's corresponding channel of operation; and
(2) upon receiving the re-association frame at said first AP, storing said second AP identifier and said corresponding channel of operation in a nearest neighbor table associated with said first AP.

14. The method of claim 13, wherein said first AP is an AP with which said STA is attempting to form an association with in said handoff and said second AP is an AP with which said STA is currently associated with.

15. A method for minimizing a communication service disruption period during a handoff of an STA in a wireless local area network (WLAN), the method comprising the acts of:
issuing from a first AP, a move-notification frame including a first AP identifier to a second AP;
upon receiving the move-notification frame at said second AP, storing said first AP identifier in a nearest neighbor table associated with said second AP; and
obtaining, by said second AP, a channel of operation corresponding to said first AP; and
storing said channel of operation corresponding to said first AP in said nearest-neighbor table.

16. The method of claim 15, wherein said act of obtaining, by said second AP, a channel of operation corresponding to said first AP is achieved via a frame exchange performed in accordance with a simple network management protocol (SNMP).

17. A method for minimizing a communication service disruption period during a handoff of an STA in a wireless local area network (WLAN), the method comprising the acts of:
(1) transmitting a move-notification frame from said STA to a first AP, said re-association frame including at least a second AP identifier and said second AP's corresponding channel of operation; and
(2) upon receiving the move-notification frame at said first AP, storing said second AP identifier and said corresponding channel of operation in a nearest neighbor table associated with said first AP.

18. A system for minimizing a communication service disruption period which occurs during handoffs in a wireless local area network (WLAN), the system comprising:
means for providing a plurality of APs in the network with an assigned channel of operation and a pre-configured nearest-neighbor table comprised of records, where each record includes at least a first field identifying a nearest neighbor AP and a second field identifying said nearest neighbor AP's channel of operation;
means for transmitting said pre-configured nearest-neighbor table from said plurality of APs to associated STAs; and
means for performing a prioritized search by said STA by first searching in each of said nearest neighbor AP's channel of operation as identified in said transmitted nearest-neighbor table to locate at least one candidate AP to form a new association with in said handoff.

19. The system of claim 18, wherein said means for transmitting said pre-configured table from said plurality of APs to associated STAs further comprises means for transmitting a modified probe response frame including said preconfigured nearest-neighbor table.

20. The system of claim 18, wherein said means for transmitting said pre-configured table from said plurality of APs to associated STAs further comprises means for transmitting a modified beacon frame including said pre-configured table.

21. The system of claim 18, wherein said means for transmitting said pre-configured table from said plurality of APs to associated STAs further comprises means for transmitting a dedicated AP channel announcement management frame including said pre-configured table.

22. The system of claim 18, further comprising:
means for changing said assigned channel of operation by one of said plurality of APs; and
means for performing a frame exchange in accordance with a simple network management protocol (SNMP) between said one of said plurality of APS and all other APs to inform said all other APs of said channel change.

23. A system for minimizing a communication service disruption period during a handoff of a mobile station (STA) in a wireless local area network (WLAN), the system comprising:
means for transmitting a re-association frame from said STA to a first AP, said re-association frame including a second AP identifier;
means for storing said second AP identifier in a nearest neighbor table associated with said first AP upon receiving the re-association frame at said first AP;
means for obtaining, by said first AP, a channel of operation corresponding to said second AP; and
means for storing said channel of operation in said nearest-neighbor table.

24. The system of claim 23, wherein said first AP is an AP with which said STA is attempting to form an association with in said handoff and said second AP is an AP with which said STA is currently associated with.

25. The system of claim 23, further comprising means for obtaining, by said first AP, a channel of operation corresponding to said second AP via a frame exchange in accordance with a simple network management protocol (SNMP).

26. A system for minimizing a communication service disruption period during a handoff of an STA in a wireless local area network (WLAN), the system comprising:
means for transmitting a re-association frame from said STA to a first AP, said re-association frame including at least a second AP identifier and said second AP's corresponding channel of operation; and
means for upon receiving the re-association frame at said first AP, storing said second AP identifier and said corresponding channel of operation in a nearest neighbor table associated with said first AP.

27. The system of claim 26, wherein said first AP is an AP with which said STA is attempting to form an association with in said handoff and said second AP is an AP with which said STA is currently associated with.

28. A system for minimizing a communication service disruption period during a handoff of an STA in a wireless local area network (WLAN), the system comprising:
means for issuing from said first AP, a move-notification frame including a first AP identifier to said second AP;
means for storing said first AP identifier in a nearest neighbor table associated with said second AP upon receiving the move-notification frame at said second AP;
means for obtaining, by said second AP, a channel of operation corresponding to said first AP; and
means for storing said channel of operation corresponding to said first AP in said table.

29. The system of claim 28, wherein said means for obtaining, by said second AP, a channel of operation corresponding to said first AP is achieved via a frame exchange in accordance with a simple network management protocol (SNMP).

30. A system for minimizing a communication service disruption period during a handoff of an STA in a wireless local area network (WLAN), the system comprising:
means for transmitting a move-notification frame from said STA to a first AP, said re-association frame including at least a second AP identifier and said second AP's corresponding channel of operation; and
means for storing said second AP identifier and said corresponding channel of operation in a nearest neighbor table associated with said first AP upon receiving the move-notification frame at said first AP.
